(19) United States
(12) Patent Application Publication
(10) Pub. No.: US 2008/0317145 A1
(43) Pub. Date: Dec. 25, 2008

(54) MULTIPLE INPUT MULTIPLE OUTPUT COMMUNICATION SYSTEM AND A METHOD OF ADAPTIVELY GENERATING CODEBOOK

(76) Inventors: Bruno CLERCKX, Yongin-si (KR); Ki Il KIM, Seongnam-si (KR); Jun Mo KIM, Seoul (KR); Sung Jin KIM, Suwon-si (KR)

Correspondence Address: MCNEELY BODENDORF LLP, P.O. BOX 34175, WASHINGTON, DC, 20043, US

(21) Appl. No.: 12/135,628

(22) Filed: Jun. 9, 2008

Related U.S. Application Data
(60) Provisional application No. 60/946,003, filed on Jun. 25, 2007.

(30) Foreign Application Priority Data
Mar. 10, 2008 (KR) 10-2008-0021873

(51) Int. Cl. H04K 1/10

(52) U.S. Cl. 375/260

(57) ABSTRACT

A Multiple-Input Multiple-Output (MIMO) communication system and a method of adaptively generating a codebook are provided. A terminal includes a channel estimator to estimate a channel formed between a base station and the terminal to calculate a channel matrix and a codebook generator to adaptively generate a codebook based on a spatial correlation matrix of the channel matrix.

### CROSS-REFERENCE TO RELATED APPLICATIONS

This application claims the benefit under 35 U.S.C. §119(e) of a U.S. Provisional Application No. 60/946,003, filed on Jun. 25, 2007, in the U.S. Patent and Trade Mark Office, and the benefit under 35 U.S.C. §119(a) of a Korean Patent Application No. 2008-0021873, filed on Mar. 10, 2008, in the Korean Intellectual Property Office, the disclosures of which are incorporated herein by reference in its entirety.

### TECHNICAL FIELD

The following description relates to a wireless communication system, and more particularly, to a Multiple-Input Multiple-Output (MIMO) communication system and a method of generating a transmission signal using a codebook in a MIMO communication system.

### BACKGROUND

A number of researches are being conducted to provide various types of multimedia services such as a voice service and to support the high quality and high speed of data transmission in a wireless communication environment. Technologies associated with a Multiple-Input Multiple-Output (MIMO) communication system using multiple channels, are in rapid development.

In a MIMO communication system, a base station and terminals may use a codebook. A particular space may be quantized into a plurality of vectors. The plurality of vectors that is generated by quantizing the particular space may be used in the base station and the terminals as the codebook.

For example, each of the terminals may select a vector from the plurality of vectors included in the codebook, based on a channel that is formed between the base station and each of the terminals. The base station may also recognize the selected vector based on the codebook. The selected vector may be used as a beamforming vector to generate a transmission signal.

Accordingly, it is desirable to effectively design a codebook to be consistent with a variable channel environment. By using a well-designed codebook, it may improve the throughput of a MIMO communication system where there is some constraint on a number of feedback bits to be allocated. For example, a MIMO communication system using a well-designed codebook may reduce a quantization error by quantizing a particular space in a wireless communication system.

### SUMMARY

In one general aspect, there is provided a terminal and a base station for adaptively generating a codebook based on a spatial correlation matrix of a channel matrix. The terminal and the base station may reduce a quantization error and improve a data transmission rate by using the codebook.

In another aspect, there is provided a terminal and a base station for selecting a preferred vector or generating a preceding matrix based on an adaptively generated codebook.

In still another aspect, there is provided a terminal and a base station for generating a codebook according to a number of adaptively varying feedback bits and performing a feedback operation.

In yet another aspect, a method of operating a terminal includes calculating a channel matrix by estimating a channel formed between a base station and a terminal, adaptively generating a codebook based on a spatial correlation matrix of the channel matrix, transmitting information associated with the spatial correlation matrix to the base station, selecting a preferred vector from the generated codebook, and feeding back information associated with the preferred vector to the base station. The selecting of the preferred vector may comprise selecting the preferred vector based on at least one of an achievable data transmission rate and an SINR.

In still yet another general aspect, a method of operating a base station includes recognizing a spatial correlation matrix from information associated with the spatial correlation matrix of a channel matrix that is received from a terminal, determining a number of feedback bits allocated to the terminal based on the spatial correlation matrix and a transmission power, reconstructing a codebook generated by the terminal according to the number of feedback bits and the spatial correlation matrix, recognizing a preferred vector from the codebook based on information associated with the preferred vector that is fed back from the terminal, generating a precoding matrix based on the preferred vector of the terminal, and generating a transmission signal to be transmitted to the terminal based on the precoding matrix.

In still yet another aspect, a terminal includes a channel estimator to estimate a channel formed between a base station and the terminal to calculate a channel matrix, and a codebook generator to adaptively generate a codebook based on a spatial correlation matrix of the channel matrix.

The codebook generator may adaptively generate the codebook according to a predetermined number of feedback bits.

The codebook generator may adaptively generate the codebook based on the spatial correlation matrix and a plurality of pre-stored vectors. The plurality of pre-stored vectors may be associated with an independent identically distributed channel.

The codebook generator may adaptively generate the codebook by grouping vectors from a plurality of pre-stored vectors associated with a dominant eigenvector of the spatial correlation matrix according to a number of feedback bits. The codebook generator may adaptively generate the codebook based on singular values of the spatial correlation matrix. The codebook generator may adaptively generate the codebook by selecting a centroid vector from the plurality of pre-stored vectors and grouping the vectors from the plurality of pre-stored vectors according to the number of feedback bits based on at least one of a correlation between the centroid vector and the plurality of pre-stored vectors, and a correlation between the plurality of pre-stored vectors, wherein the centroid vector maximizes an inner product between the plurality of pre-stored vectors and the dominant eigenvector. The plurality of pre-stored vectors may be vectors that are included in a discrete Fourier transform (DFT) codebook.

The terminal may further comprise an information transmitter to transmit information associated with the spatial correlation matrix to the base station. The information transmitter may transmit, to the base station, information associated with at least one element of elements that are included in the spatial correlation matrix.

The terminal may further comprise a preferred vector selector to select at least one preferred vector from vectors that are included in the adaptively generated codebook, based on at least one of an achievable data transmission rate and a signal-to-interference and noise ratio (SINR). The terminal may further comprise a feedback unit to feed back information associated with the at least one preferred vector to the base station. The information associated with the at least one preferred vector may be quantized according to a predetermined number of feedback bits. The predetermined number of feedback bits may be determined by the base station.

The channel matrix may be expressed in a vector form where the terminal is provided with a single antenna.

In still yet another aspect, a base station includes a spatial correlation matrix recognition unit to recognize a spatial correlation matrix based on information associated with the spatial correlation matrix of a channel matrix of a terminal, and a codebook reconstruction unit to reconstruct a codebook generated by the terminal based on a number of feedback bits and the spatial correlation matrix. The feedback bits may be allocated to the terminal based on the spatial correlation matrix.

The base station may further comprise a feedback bit amount determining unit to determine a portion of limited total bits or all of the limited total bits as the number of feedback bits allocated to the terminal, based on the spatial correlation matrix and a transmission power. The feedback bit amount determining unit may determine the number of feedback bits allocated to the terminal based on singular values of the spatial correlation matrix. Where the transmission power is high, the feedback bit amount determining unit may increase the number of feedback bits allocated to the terminal as the spatial correlation of the channel increases, and where the transmission power is low, the feedback bit amount determining unit may increase the number of feedback bits allocated to the terminal as the spatial correlation of the channel decreases. The feedback bit amount determining unit may adjust the number of feedback bits allocated to the terminal in proportion to the transmission power.

Information associated with the spatial correlation matrix may include information associated with at least one element of elements that are included in the spatial correlation matrix.

The codebook reconstruction unit may reconstruct the codebook generated by the terminal based on the spatial correlation matrix and a plurality of pre-stored vectors.

The codebook reconstruction unit may reconstruct the codebook by grouping vectors from a plurality of pre-stored vectors according to the number of feedback bits allocated to the terminal, based on a dominant eigenvector of the spatial correlation matrix. The codebook reconstruction unit may reconstruct the codebook based on singular values of the spatial correlation matrix.

The base station may further comprise a preferred vector recognition unit to recognize a preferred vector from vectors included in the codebook, based on information associated with the preferred vector that is fed back from the terminal. The base station may further comprise a precoding matrix generator to generate a precoding matrix based on the preferred vector of the terminal and preferred vectors corresponding to other terminals. The base station may further comprise a beamformer to generate a transmission signal to be transmitted to the terminal, or a portion of the other terminals, or all of the terminals, based on the precoding matrix.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an exemplary multi-user Multiple-Input Multiple-Output (MIMO) communication system;

FIG. 2 is a diagram illustrating a conceptual diagram of a multi-user MIMO communication system according to an exemplary embodiment.

FIG. 3 is a flowchart illustrating a method of operating a terminal according to an exemplary embodiment.

FIG. 4 is a flowchart illustrating a method of operating a base station according to an exemplary embodiment.

FIG. 5 is a block diagram illustrating a base station and a terminal according to an exemplary embodiment.

Throughout the drawings and the detailed description, unless otherwise described, the same drawing reference numerals will be understood to refer to the same elements, features, and structures. The elements may be exaggerated for clarity and convenience.

### DETAILED DESCRIPTION

The following detailed description is provided to assist the reader in gaining a comprehensive understanding of the media, apparatuses, methods and/or systems described herein. Accordingly, various changes, modifications, and equivalents of the systems, methods, apparatuses and/or media described herein will be suggested to those of ordinary skill in the art. Also, description of well-known functions and constructions are omitted to increase clarity and conciseness.

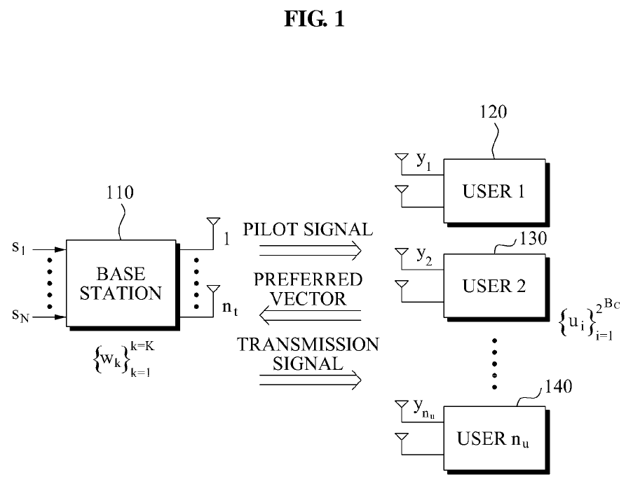

FIG. 1 illustrates an example of a multi-user Multiple-Input Multiple-Output (MIMO) communication system.

The multi-user MIMO communication system includes a base station 110 and a plurality of users (user 1, user 2, user nᵤ) 120, 130, and 140. A plurality of antennas may be installed in the base station 110. A single antenna or a plurality of antennas may be installed in each of the users (user 1, user 2, user nᵤ) 120, 130, and 140. A channel may be formed between the base station 110 and each of the users (user 1, user 2, user nᵤ) 120, 130, and 140. The base station 110 may communicate with each of the users (user 1, user 2, user nᵤ) 120, 130, and 140 via the formed channel.

The base station 110 may transmit at least one data stream to the plurality of users (user 1, user 2, user nᵤ) 120, 130, and 140. The base station 110 may perform beamforming for the data streams according to a spatial division multiplex access (SDMA) scheme to thereby generate a transmission signal. The base station 110 may generate a precoding matrix based on a codebook and generate the transmission signal based on the generated preceding matrix.

The base station 110 may transmit pilot signals to the plurality of users (user 1, user 2, user nᵤ) 120, 130, and 140 via a downlink channel. The pilot signals may be well-known to the base station 110 and the plurality of users (user 1, user 2, user nᵤ) 120, 130, and 140.

Each of the users (user 1, user 2, user nᵤ) 120, 130, and 140 may receive the pilot signal to estimate a channel Hₖ, where k is a user index. As described above, the channel Hₖ may be formed between the base station and the plurality of users (user 1, user 2, user nᵤ) 120, 130, and 140. Each of the users (user 1, user 2, user nᵤ) 120, 130, and 140 may select, as a preferred vector, any one vector from vectors

$${\{ {u}_{i}^{( c )} \}}_{i = 1}^{{2}^{{B}_{c}}}$$

that are included in a pre-stored codebook, based on the estimated channel Hₖ. In

$${\{ {u}_{i}^{( c )} \}}_{i = 1}^{{2}^{{B}_{c}}} ,$$

uᵢ^{(c)} is an i^{th} vector included in the codebook, B_{c} is a number of feedback bits for an user c and user dependent value. Where the number of bits is B_{c} bits, 2^{Bc} vectors may be generated by quantizing a space and be stored in the codebook. The users may have the same number of feedback bits, or have a different number of feedback bits according to various system conditions such as a different channel environment, a signal-to-interference noise ratio (SINR), and the like.

Each of the users (user 1, user 2, user nᵤ) 120, 130, and 140 may select, as the preferred vector, any one vector from the 2^{Bc} vectors, based on various system conditions.

For example, each of the users (user 1, user 2, user nᵤ) 120, 130, and 140 may select, as the preferred vector, any one vector from the 2^{B} vectors, based on an achievable data transmission rate or an SINR. Each of the users (user 1, user 2, user nᵤ) 120, 130, and 140 may also determine its own preferred transmission rank, which is a number of data streams. In this case, vectors corresponding to the number of data streams may be selected as preferred vectors from the 2^{Bc} vectors.

Each of the users (user 1, user 2, user nᵤ) 120, 130, and 140 may feed back information associated with the selected preferred vector to the base station 110. Information associated with the selected preferred vector may be referred to as channel direction information (CDI).

The base station 110 may receive information associated with the preferred vector of each of the users (user 1, user 2, user nᵤ) 120, 130, and 140 and may determine a precoding matrix (Wₖ) and the precoding matrix (Wₖ) is an element of a set

$${\{ {W}_{k} \}}_{k = 1}^{k = K} .$$

The base station 110 may select a portion of or all of the users (user 1, user 2, user nᵤ) 120, 130, and 140 according to various types of user selection algorithms such as a semi-orthogonal user selection (SUS) algorithm, a greedy user selection (GUS) algorithm, and the like.

The same codebook as the codebook that is stored in the plurality of users (user 1, user 2, user nᵤ) 120, 130, and 140 may be pre-stored in the base station 110.

The base station 110 may determine the precoding matrix (Wₖ) from the pre-stored codebook, based on information associated with the preferred vector that is received from the plurality of users (user 1, user 2, user nᵤ) 120, 130, and 140. But, the base station 110 could directly build the precoding matrix (Wₖ) based on all combination of possible vectors feedback by the users (user 1, user 2, user nᵤ) 120, 130, and 140. In this case, the base station 110 may not pre-store the codebook.

The base station 110 may determine the precoding matrix (Wₖ) to maximize a total data transmission rate, that is, a sum rate.

The base station 110 may perform precoding for data streams S₁ and S_{N} based on the determined precoding matrix (Wₖ) to thereby generate the transmission signal. A process of generating the transmission signal by the base station 110 may be referred to as “beamforming.”

However, the channel environment between the base station 110 and the plurality of users (user 1, user 2, user nᵤ) 120, 130, and 140 may be variable. Where the base station 110 and the plurality of users (user 1, user 2, user nᵤ) 120, 130, and 140 are fixed and use the same codebook, it may be difficult to adaptively cope with the varying channel environment. For example, where the codebook is fixed, the plurality of users (user 1, user 2, user nᵤ) 120, 130, and 140 may feed back information associated with the preferred vector to the base station 110 based on the fixed number of feedback bits. In this case, the base station 110 may not determine a precoding matrix that is appropriate for the channel environment.

Accordingly, there is a need for technology to adaptively cope with the channel environment to improve the performance of the multi-user MIMO communication system.

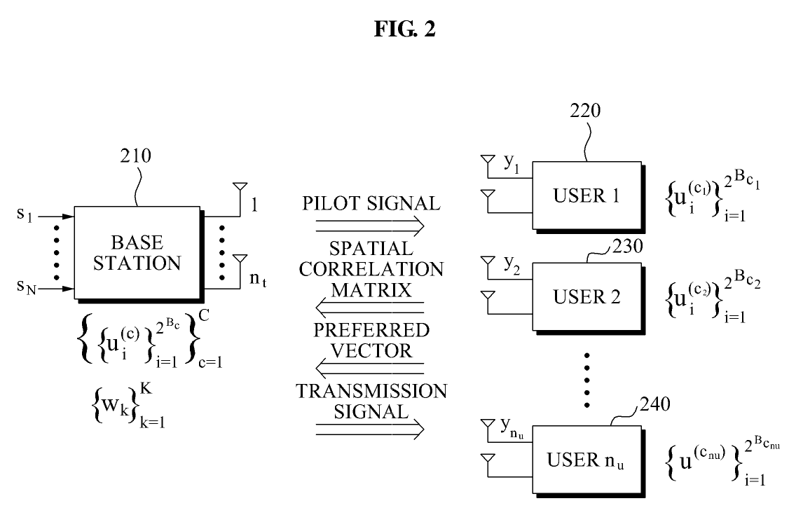

FIG. 2 illustrates a conceptual diagram of a multi-user MIMO communication system according to an exemplary embodiment.

The multi-user MIMO communication system includes a base station 210 and a plurality of users (user 1, user 2, user nᵤ) 220, 230, and 240.

The base station 210 may transmit pilot signals to the plurality of users (user 1, user 2, user nᵤ) 220, 230, and 240. Each of the users (user 1, user 2, user nᵤ) 220, 230, and 240 may estimate a channel, formed between the base station 210 and each of the plurality of users (user 1, user 2, user nᵤ) 220, 230, and 240, based on the pilot signal and may calculate a channel matrix Hₖ, where k is a user index.

Each of the users (user 1, user 2, . . . , user nᵤ) 220, 230, and 240 may calculate a spatial correlation matrix Rₖ of the channel matrix Hₖ based on the calculated channel matrix Hₖ. The spatial correlation matrix Rₖ may be calculated as given by the following Equation 1:

$${R}_{k} ( t ) = \frac{1}{T} {\sum }_{j = 0}^{T} {H}_{k}^{H} ( t - j ) {H}_{k} ( t - j ) , \qquad ( 1 )$$

where Hₖ(t) is a channel matrix of an estimated channel in a time t and T is a time slot corresponding to a calculation target of the spatial correlation matrix Rₖ.

Each of the users (user 1, user 2, user nᵤ) 220, 230, and 240 may adaptively generate a codebook based on the calculated spatial correlation matrix Rₖ. Therefore, codebooks to be used by the plurality of users (user 1, user 2, user nᵤ) 220, 230, and 240, respectively, may be different from each other depending on the spatial correlation matrix Rₖ of each of the users (user 1, user 2, user nᵤ) 220, 230, and 240. The codebooks may be generated based on the spatial correlation matrix Rₖ according to various types of schemes. Hereinafter, exemplary processes of generating a codebook will be described below. Also, an exemplary process of informing the base station 210 the codebooks used by the plurality of users (user 1, user 2, user nᵤ) 220, 230, and 240 will be described below.

A process of generating codebooks by users and identifying the generated codebooks by a base station is described below.

1. A First Codebook Generation Scheme

The base station 210 and the plurality of users (user 1, user 2, user nᵤ) 220, 230, and 240 may prestore a plurality of vectors. Where a number of feedback bits is determined as B_{c}, the base station 210 and the plurality of users (user 1, user 2, user nᵤ) 220, 230, and 240 may pre-store 2^{Bc} vectors. Where it is assumed that an i^{th} vector among the plurality of pre-stored vectors is wᵢ, a 2^{Bc} number of wᵢ may be associated with an independent identically distributed channel. For example, the 2^{Bc} number of wᵢ may be vectors that satisfy Grassmanian line packing requirements.

The base station 210 and the plurality of users (user 1, user 2, user nᵤ) 220, 230, and 240 may generate a codebook based on a spatial correlation matrix Rₖ and the pre-stored 2^{Bc} vectors. Where an i^{th} vector of a codebook used by a user k is uᵢ^{(c)}, the user k may adaptively generate the code book as given by the following Equation 2:

$${\{ {u}_{i}^{( c )} \}}_{i = 1}^{{2}^{{B}_{c}}} = \{ \frac{{R}_{k}^{1 / 2} {w}_{1}}{{‖ {R}_{k}^{1 / 2} {w}_{1} ‖}_{2}} , … , \frac{{R}_{k}^{1 / 2} {w}_{{2}^{{B}_{c}}}}{{‖ {R}_{k}^{1 / 2} {w}_{{2}^{{B}_{c}}} ‖}_{2}} \} , \qquad ( 2 )$$

where ∥a∥₂ is a 2-norm of a.

Accordingly, the users (user 1, user 2, user nᵤ) 220, 230, and 240 may generate codebooks

$${\{ {u}_{i}^{( {c}_{1} )} \}}_{i = 1}^{{2}^{{B}_{{c}_{1}}}} , {\{ {u}_{i}^{( {c}_{2} )} \}}_{i = 1}^{{2}^{{B}_{{c}_{2}}}} , and {\{ {u}_{i}^{( {c}_{{n}_{u}} )} \}}_{i = 1}^{{2}^{{B}_{{c}_{{n}_{u}}}}} ,$$

respectively. The codebooks

$${\{ {u}_{i}^{( {c}_{1} )} \}}_{i = 1}^{{2}^{{B}_{{c}_{1}}}} , {\{ {u}_{i}^{( {c}_{2} )} \}}_{i = 1}^{{2}^{{B}_{{c}_{2}}}} , and {\{ {u}_{i}^{( {c}_{{n}_{u}} )} \}}_{i = 1}^{{2}^{{B}_{{c}_{{n}_{u}}}}}$$

may be different from each other. Each of the users (user 1, user 2, user nᵤ) 220, 230, and 240 may have the same number of feedback bits or may have a different number of feedback bits. Each of the users (user 1, user 2, user nᵤ) 220, 230, and 240 may also adaptively generate the codebook according to the channel environment.

The plurality of users (user 1, user 2, user nᵤ) 220, 230, and 240 may transmit information associated with the generated codebooks to the base station 210 so that when the base station 210 identifies the codebooks of the plurality of users (user 1, user 2, user nᵤ) 220, 230, and 240, the base station 210 may recognize a preferred vector corresponding to each of the users (user 1, user 2, user nᵤ) 220, 230, and 240 based on feedback information transmitted from the plurality of users (user 1, user 2, user nᵤ) 220, 230, and 240.

The plurality of users (user 1, user 2, user nᵤ) 220, 230, and 240 may transmit information associated with the generated codebooks to the base station 210 according to various types of schemes. For example, the plurality of users (user 1, user 2, user nᵤ) 220, 230, and 240 may quantize all of the generated codebooks or all of the spatial correlation matrices, and transmit the quantized codebooks or spatial correlation matrices to the base station 210. The base station 210 may recognize the generated codebooks by estimating the uplink channels and determining the spatial correlation matrices corresponding to the downlink channels.

According to an aspect, to decrease the overhead of the MIMO communication system, the users (user 1, user 2, user nᵤ) 220, 230, and 240 may transmit information associated with the spatial correlation matrices to the base station without quantizing all of the spatial correlation matrices. The base station 210 may rebuild the spatial correlation matrices based on the transmitted information.

In a communication system with a uniform linear array antenna, the spatial correlation matrix may be modeled as given by the following Equation 3:

$${R}_{t} = [ \begin{matrix}1 & t & {t}^{2} & {t}^{3} \\ {t}^{*} & 1 & t & {t}^{2} \\ {t}^{* 2} & {t}^{*} & 1 & t \\ {t}^{* 3} & {t}^{* 2} & {t}^{*} & 1\end{matrix} ] . \qquad ( 3 )$$

Since the spatial correlation matrix Rₜ may be modeled as a function of t, the users (user 1, user 2, user nᵤ) 220, 230, and 240 may feed back, to the base station 210, any one element of elements that are included in the spatial correlation matrix instead of the whole spatial correlation matrix. For example, the users (user 1, user 2, user nᵤ) 220, 230, and 240 may transmit ‘t’ to the base station 210. The base station 210 may reconstruct the spatial correlation matrices based on ‘t’. The base station 210 may reconstruct the codebooks generated by the users (user 1, user 2, user nᵤ) 220, 230, and 240, based on Equation 2. Each of the users (user 1, user 2, user nᵤ) 220, 230, and 240 may quantize ‘t’ and transmit the quantization result to the base station 210, as is. The base station 210 may rebuild the correlation matrix using Equation 3 and build the appropriate codebook Also, each of the users (user 1, user 2, user nᵤ) 220, 230, and 240 may generate a codebook corresponding to ‘t’ and feed back index information of the generated codebook. In this case, the index that is feedback to the base station 210 corresponds to the codebook index. There is a unique mapping between a codebook and the quantized value of ‘t’.

According to an aspect, the users (user 1, user 2, user nᵤ) 220, 230, and 240 may transmit information associated with the spatial correlation matrices to the base station 210 with relatively less overhead. The base station 210 may readily reconstruct the codebooks generated by the users (user 1, user 2, user nᵤ) 220, 230, and 240.

The base station 210 may pre-store, in a memory, codebooks

$${\{ {\{ {u}_{i}^{( c )} \}}_{i = 1}^{{2}^{{B}_{c}}} \}}_{c = 1}^{C}$$

that may be generated by the users (user 1, user 2, user nᵤ) 220, 230, and 240 with respect to each of possible spatial correlation matrices. The base station 210 may receive information associated with the spatial correlation matrix from the users (user 1, user 2, user nᵤ) 220, 230, and 240 and retrieve the codebooks generated by the users (user 1, user 2, user nᵤ) 220, 230, and 240, by referring to the memory. In this case, the base station 210 may retrieve the generated codebooks by downloading the codebooks without reconstructing the codebooks.

2. A Second Codebook Generation Scheme

The users (user 1, user 2, user nᵤ) 220, 230, and 240 may adaptively generate codebooks by grouping some vectors from a plurality of pre-stored vectors according to a spatial correlation matrix. The users (user 1, user 2, user nᵤ) 220, 230, and 240 may generate the codebooks by grouping vectors corresponding to a number of feedback bits allocated to each of the users (user 1, user 2, user nᵤ) 220, 230, and 240. For example, where the user (user 1) 220 pre-stores eight vectors and two bits of feedback bits are allocated to the user (user 1) 220, the user (user 1) 220 may generate the codebook by grouping four vectors from the plurality of pre-stored vectors.

The plurality of vectors pre-stored by the users (user 1, user 2, user nᵤ) 220, 230, and 240 may be vectors that are included in a discrete Fourier transform (DFT) codebook. The DFT codebook F may be expressed by the following Equation 4:

$$F = \{ {F}^{( 0 )} … {F}^{( {2}^{{B}^{′}} - 1 )} \} , \\ {F}^{( b )} = [ {f}_{0}^{( b )} … {f}_{n t - 1}^{( b )} ] , \\ {f}_{m}^{( b )} = {\frac{1}{\sqrt{{n}_{t}}} [ {f}_{0 m}^{( b )} … {f}_{( {n}_{t} - 1 ) m}^{( b )} ]}^{T} , \\ {f}_{n m}^{( b )} = exp \{ j \frac{2 π n}{{n}_{t}} ( m + \frac{b}{{2}^{{B}^{′}}} ) \} , \qquad ( 4 )$$

where B′ is associated with the size of the DFT codebook.

For example, it is assumed that where B′=1, a user i pre-stores vectors f₀⁽⁰⁾, f₁⁽⁰⁾, f₂⁽⁰⁾, f₃⁽⁰⁾, f₁⁽¹⁾, f₁⁽¹⁾, f₂⁽¹⁾, and f₃⁽¹⁾ that are included in F⁽⁰⁾ and F⁽¹⁾. nₜ is ‘4’. F⁽⁰⁾ and F⁽¹⁾ may be expressed by the following Equation 5:

$$\begin{matrix}{F}^{( 0 )} = [ {f}_{0}^{( 0 )} … {f}_{3}^{( 0 )} ] \\ = \frac{1}{\sqrt{4}} [ \begin{matrix}1 & 1 & 1 & 1 \\ 1 & {e}^{jπ / 2} & {e}^{jπ} & {e}^{j3π / 2} \\ 1 & {e}^{jπ} & {e}^{j2π} & {e}^{j3π} \\ 1 & {e}^{j3π / 2} & {e}^{j3π} & {e}^{j9π / 2}\end{matrix} ] , \\ {F}^{( 1 )} = [ {f}_{0}^{( 1 )} … {f}_{3}^{( 1 )} ] \\ = \frac{1}{\sqrt{4}} [ \begin{matrix}1 & 1 & 1 & 1 \\ {e}^{jπ / 4} & {e}^{j3π / 4} & {e}^{j5π / 4} & {e}^{j7π / 4} \\ {e}^{jπ / 2} & {e}^{j3π / 2} & {e}^{j5π / 4} & {e}^{j7π / 2} \\ {e}^{j3π / 4} & {e}^{j9π / 4} & {e}^{j15π / 4} & {e}^{j21π / 4}\end{matrix} ] .\end{matrix} \qquad ( 5 )$$

Where two bits of feedback bits are allocated to the user i, the user i may adaptively generate the codebook by grouping four vectors from the pre-stored eight vectors f₀⁽⁰⁾, f₁⁽⁰⁾, f₂⁽⁰⁾, f₃⁽⁰⁾, f₀⁽¹⁾, f₁⁽¹⁾, f₂⁽¹⁾, and f₃⁽¹⁾.

In particular, the user i may group vectors corresponding to the number of feedback bits from the plurality of pre-stored vectors according to the following Equation 6:

$${\hat{f}}_{i} = {arg max}_{b , m} \vert {v}_{i , 1} {f}_{m}^{( b )} \vert , \qquad ( 6 )$$

where v_{i,1} is a dominant eigenvector of the spatial correlation matrix Rₖ of the user i.

In Equation 6, the user i may select a centroid vector \hat{f}ᵢ from the plurality of pre-stored plurality of vectors based on the dominant eigenvector of the spatial correlation matrix Rₖ. Where Bᵢ feedback bits are allocated to the user i, the user i may further select 2^{Bi-1} vectors from the plurality of pre-stored vectors based on the centroid vector \hat{f}ᵢ.

Accordingly, 2^{Bi} vectors may be selected and the selected 2^{Bi} vectors may constitute a new codebook corresponding to the user i. The user i may adaptively generate the codebook by grouping a portion of the pre-stored vectors or all of the pre-stored vectors.

The user i may select 2^{Bi-1} vectors to minimize the mutual correlation between the grouped 2^{Bi} vectors and to satisfy the following Equation 7:

$$1 - \vert {\hat{f}}_{i}^{H} {f}_{m}^{( b )} \vert \leq \frac{{σ}_{i , 2}^{2}}{{σ}_{i , 1}^{2}} , \qquad ( 7 )$$

where σ_{i,1} and σ_{i,2} are the largest singular value and a second largest singular value among singular values of the spatial correlation matrix Rₖ of the user i.

For example, where the user i pre-stores eight vectors f₀⁽⁰⁾, f₁⁽⁰⁾, f₂⁽⁰⁾, f₃⁽⁰⁾, f₀⁽¹⁾, f₁⁽¹⁾, f₂⁽¹⁾, and f₃⁽¹⁾, the user i may generate, as the codebook, any one of the four vectors f₀⁽⁰⁾, f₁⁽⁰⁾, f₂⁽⁰⁾, and f₃⁽⁰⁾, or any one of the remaining four vectors f₀⁽¹⁾, f₁⁽¹⁾, f₂⁽¹⁾, and f₃⁽¹⁾. And, the user i may generate the vectors f₀⁽⁰⁾, f₀⁽¹⁾, f₁⁽⁰⁾, and f₁⁽¹⁾ as the codebook.

The user i and the base station 210 may pre-store a plurality of codebooks based on

$$\frac{{σ}_{i , 2}}{{σ}_{i , 1}}$$

and the number of allocated feedback bits Bi. The user i may generate, as a new codebook, any one of the plurality of pre-stored codebooks based on the number of allocated feedback bits Bi. The user i may feed back index information of the newly generated codebook to the base station 210. The base station 210 may readily recognize the generated codebook of the user i.

It is understood that the process of adaptively generating the codebook by the users (user 1, user 2, user nᵤ) 220, 230, and 240 and the process of identifying the generated codebook by the base station 210 described above are only exemplary. In view of the teachings provided herein, it will be readily appreciated by those skilled in the art that another scheme known or to be known may be used to adaptively generate a codebook based on a spatial correlation matrix.

Where new codebooks are generated by the plurality of users (user 1, user 2, user nᵤ) 220, 230, and 240, each of the users (user 1, user 2, user nᵤ) 220, 230, and 240 may select its own preferred vector based on the generated codebooks. Each of the users (user 1, user 2, user nᵤ) 220, 230, and 240 may feed back information associated with the selected preferred vector such as an index of the selected preferred vector, to the base station 210.

The base station 210 may identify the codebooks generated by the plurality of users (user 1, user 2, user nᵤ) 220, 230, and 240. Therefore, the base station 210 may generate a precoding matrix (Wₖ) based on information associated with the selected preferred vector. The base station 210 may generate the precoding matrix (Wₖ) based on a transmission rank, a sum of achievable data transmission rates, and the like.

The base station 210 may perform beamforming for a data stream based on the generated precoding matrix (Wₖ) to thereby generate the transmission signal.

A process of determining the number of feedback bits Bi of the user i by the base station 210 is described below.

A total sum Bₜₒₜ of the number of feedback bits allocated to the users (user 1, user 2, user nᵤ) 220, 230, and 240 may be limited because the MIMO communication system may have the limited total number of feedback bits. In this case, where the same number of feedback bits is allocated to each of the users (user 1, user 2, user nᵤ) 220, 230, and 240, it may be inappropriate for the channel environment of each of the users (user 1, user 2, user nᵤ) 220, 230, and 240 and thus ineffective.

According to an aspect, a number of feedback bits corresponding to each of the users (user 1, user 2, user nᵤ) 220, 230, and 240 may be determined before each of the users (user 1, user 2, user nᵤ) 220, 230, and 240 generates a codebook. In particular, the base station 210 may allocate the number of feedback bits corresponding to each of the users (user 1, user 2, user nᵤ) 220, 230, and 240, depending on the channel environment of each of the users (user 1, user 2, user nᵤ) 220, 230, and 240.

For example, where the power of the transmission signal is high, the base station 210 may allocate a relatively large number of feedback bits to a user having a channel with a large correlation. Conversely, the base station 210 may allocate a relatively less number of feedback bits to a user having a channel with a less correlation.

The base station 210 may allocate the number of feedback bits Bi to the user i according to the following Equation 8:

$${B}_{i}^{*} = {[ - 2 ( {r}_{i} - 1 ) {log}_{2} ( \frac{1}{2} \frac{{b}_{i}}{{a}_{i}} \frac{( v - \frac{1}{2 ( {r}_{i} - 1 )} )}{( v - \frac{1}{( {r}_{i} - 1 )} )} [ - 1 - \sqrt{1 - 4 \frac{{a}_{i}}{{b}_{i}^{2}} \frac{( v - \frac{1}{{r}_{i} - 1} )}{{( v - \frac{1}{2 ( {r}_{i} - 1 )} )}^{2}} v} ] ) ]}^{+} , \qquad ( 8 )$$

where

$${a}_{i} = \frac{P}{M} ( M - 1 ) {n}_{t} \frac{{σ}_{2 , i}^{2}}{{σ}_{1 , i}^{2}} , {b}_{i} = \frac{P}{M} ( M - 1 ) {ρ}_{i} \sqrt{2 {n}_{t}} \frac{{σ}_{2 , i}}{{σ}_{1 , i}} , v$$

is selected to satisfy Σ_{iετB}ᵢ^{★}=Bₜₒₜ, Bₜₒₜ is a number of feedback bits allocated to the entire MIMO communication system, M is a number of simultaneously scheduled users, P is the entire transmission power, τ is a set of scheduled users, and rᵢ is a transmission rank of the user i.

The base station 210 may determine the number of feedback bits Bi based on the spatial correlation matrix or singular values of the spatial correlation matrix. The solution of Equation 8 may be obtained according to a numerical method based on a constraint that the number of feedback bits Bi is greater than or equal to ‘0’. Where the solution less than ‘0’ is obtained, the number of feedback bits Bi may be regarded as ‘0’.

As a unique case, where ρᵢ=0 ∀i ε τ, where ρᵢ is a mutual correlation coefficient between ∥h∥² and 1−| h̅^{H}ĥ|², h is a channel matrix where a number of antennas of the user is one,

$$\overline{h} = \frac{h}{‖ h ‖} ,$$

and ĥ is a preferred vector, Equation 8 may be represented by the following Equation 9:

$${B}_{i}^{*} = \{ \begin{matrix}0 \\ ( {r}_{i} - 1 ) {log}_{2} ( {a}_{i} [ \frac{1}{( {r}_{i} - 1 ) v} - 1 ] ) ,\end{matrix} \\ if v \geq \frac{1}{{r}_{i} - 1} \frac{{a}_{i}}{1 + {a}_{i}} \\ if v < \frac{1}{{r}_{i} - 1} \frac{{a}_{i}}{1 + {a}_{i}} . \qquad ( 9 )$$

As another unique case, where ρᵢ=0 and rᵢ=r ∀i ε τ, Equation 8 may be represented by the following Equation 10:

$${B}_{i}^{*} = ( r - 1 ) {log}_{2} ( \frac{{σ}_{2 , i}^{2} / {σ}_{1 , i}^{2}}{{[ {\prod }_{k ∈ τ} {σ}_{2 , k}^{2} / {σ}_{1 , k}^{2} ]}^{1 / M}} ) + \frac{{B}_{tot}}{M} , \qquad ( 10 )$$

where k={i ε τ|rᵢ>1}.

From Equation 10, the base station 210 may determine a number of feedback bits corresponding to the user i based on singular values of the spatial correlation matrix. Where the transmission power of the base station 210 is high, that is, where the transmission signal of the base station 210 has a high signal-to-noise ratio (SNR), the number of feedback bits to be allocated to the user i may be determined according to the following Equation 11:

$${B}_{i}^{*} = \{ \begin{matrix}0 & if i ∉ ζ \\ ( {r}_{min} - 1 ) {log}_{2} ( \frac{{σ}_{2 , i}^{2} / ( {ρ}_{i}^{2} {σ}_{1 , i}^{2} )}{{[ {\prod }_{k ∈ ζ} {σ}_{2 , k}^{2} / ( {ρ}_{k}^{2} {σ}_{1 , k}^{2} ) ]}^{1 / \# ζ}} ) + \frac{{B}_{tot}}{\# ζ} & if i ∈ ζ\end{matrix} \\ if {ρ}_{i} > 0 ∀ i ∈ ζ , and \\ {B}_{i}^{*} = \{ \begin{matrix}0 & if i ∉ ζ \\ ( {r}_{min} - 1 ) {log}_{2} ( \frac{{σ}_{2 , i}^{2} / {σ}_{1 , i}^{2}}{{[ {\prod }_{k ∈ ζ} {σ}_{2 , k}^{2} / {σ}_{1 , k}^{2} ]}^{1 / \# ζ}} ) + \frac{{B}_{tot}}{\# ζ} & if i ∈ ζ\end{matrix} \\ if {ρ}_{i} = 0 ∀ i ∈ ζ . \\ where {r}_{min} = {min}_{k ∈ κ} {r}_{k} \\ and \\ ζ = \{ i ∈ κ \vert {r}_{i} = {r}_{min} \} . , \qquad ( 11 )$$

From Equation 11, a relatively large number of feedback bits may be allocated to users that have the smallest transmission rank greater than 1. Where the transmission signal of the transmission signal of the base station 210 has a high SNR and #ζ=1, the base station 210 may allocate all of the bits to the user that has the smallest transmission rank greater than 1 and allocate a zero bit to the remaining users.

Where the transmission power of the base station 210 is low, that is, where the SNR of the transmission signal is low, the base station 210 may allocate the number of feedback bits to the user i according to the following Equation 12:

$${B}_{i}^{*} = - 2 ( {r}_{i} - 1 ) {log}_{2} ( \frac{- {ρ}_{i} / 2 + \sqrt{{ρ}_{i}^{2} / 4 + 2 ( {r}_{i} - 1 ) ν}}{\sqrt{2 {n}_{t}} {σ}_{2 , i} / {σ}_{1 , i}} ) . \qquad ( 12 )$$

Where the SNR of the transmission signal is low and ρᵢ=0 ∀i ε τ, the base station 210 may allocate the number of feedback bits to the user i according to the following Equation 13:

$${B}_{i}^{*} = \{ \begin{matrix}0 & if {r}_{1} = 1 \\ \frac{{r}_{i} - 1}{{\sum }_{k ∈ κ} ( {r}_{k} - 1 )} [ {B}_{tot} + {\sum }_{k ∈ κ \backslash \{ i \}} ( {r}_{k} - 1 ) {log}_{2} ( \frac{{σ}_{2 , i}^{2} / {σ}_{1 , i}^{2}}{{σ}_{2 , k}^{2} / {σ}_{1 , k}^{2}} \frac{{r}_{k} - 1}{{r}_{i} - 1} ) ] & if {r}_{i} > 1.\end{matrix} \qquad ( 13 )$$

Referring to Equations 8 through 13, where the SNR of the transmission signal is high, a relatively large number of feedback bits may be allocated to users that have an ill-conditioned spatial correlation matrix. Conversely, where the SNR of the transmission signal is low, the relatively large number of feedback bits may be allocated to users that have a well-conditioned spatial correlation matrix.

Accordingly, where an SNR of a transmission signal is high, a base station may increase a number of feedback bits to be allocated to users that have a channel with a high spatial correlation. Conversely, where the SNR of the transmission signal is low, the base station may increase the number of feedback bits to be allocated to users that have a channel with a low spatial correlation.

Scalable Feedback

Generally, a data transmission rate may be improved as the power of a transmission signal increases. Where the power of the transmission signal exceeds a predetermined level, the power of the transmission signal may increase while the data transmission rate may not further increase. In this case, the data transmission rate may be improved by increasing the number of feedback bits.

The base station 210 may adjust the number of feedback bits as the SNR of the transmission signal increases. Specifically, the base station 210 may adjust the number of feedback bits according to the following Equation 14 and Equation 15:

$${B}_{i} = ( {r}_{i} - 1 ) {log}_{2} ( \frac{{σ}_{i , 2}^{2}}{{σ}_{i , 1}^{2}} ) - 2 ( {r}_{i} - 1 ) {log}_{2} ( \frac{- {ρ}_{i} + \sqrt{{ρ}_{i} + \frac{2 ( b - 1 ) M}{( M - 1 ) P}}}{\sqrt{2 {n}_{t}}} ) , \qquad ( 14 )$$

where ρᵢ is small, and

$${B}_{i} \approx \frac{( {r}_{i} - 1 )}{3} {P}_{dB} - ( {r}_{i} - 1 ) {log}_{2} ( b - 1 ) + ( {r}_{i} - 1 ) {log}_{2} ( \frac{{σ}_{i , 2}^{2}}{{σ}_{i , 1}^{2}} ) + ( {r}_{i} - 1 ) {log}_{2} ( \frac{( M - 1 ) {n}_{t}}{M} ) , \qquad ( 15 )$$

where ρᵢ is large and P is very large.

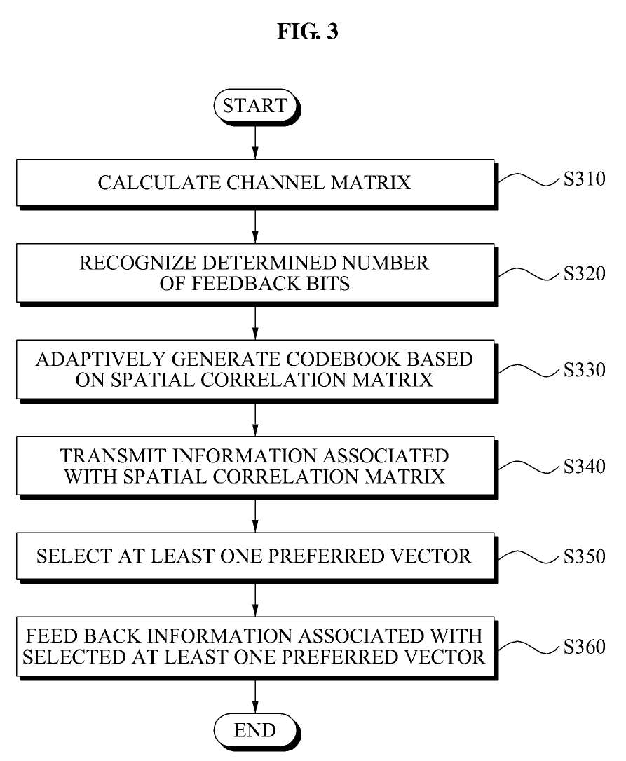

FIG. 3 is a flowchart illustrating a method of operating a terminal according to an exemplary embodiment.

In operation S310, a terminal may estimate a channel formed between a base station and the terminal and calculate a channel matrix.

In operation S320, the terminal may recognize a number of feedback bits that is determined by the base station. The base station may determine a portion of limited total feedback bits as the number of feedback bits for the terminal depending on a channel environment of the terminal. The terminal may recognize the determined number of feedback bits based on information associated with the number of feedback bits that is received from the base station.

In operation S330, the terminal may adaptively generate a codebook based on a spatial correlation matrix of the channel matrix.

According to an aspect, the operation S330 may be an operation where the terminal adaptively generates the codebook according to the predetermined number of feedback bits. The operation S330 may also be an operation of adaptively generating the codebook based on the spatial correlation matrix and a plurality of pre-stored vectors.

According to an aspect, the operation S330 may be an operation of adaptively generating the codebook by grouping vectors from the plurality of pre-stored vectors according to the number of feedback bits, based on a dominant eigenvector of the spatial correlation matrix. In this case, singular values of the spatial correlation matrix may be used. The operation S330 may be an operation for adaptively generating the codebook by selecting a centroid vector from the plurality of pre-stored vectors and grouping the vectors from the plurality of pre-stored vectors according to the number of feedback bits based on at least one of a correlation between the centroid vector and the plurality of pre-stored vectors, and a correlation between the plurality of pre-stored vectors. The centroid vector may maximize an inner product between the plurality of pre-stored vectors and the dominant eigenvector.

In operation S340, the terminal may transmit information associated with the spatial correlation matrix to the base station. According to an aspect, the operation S340 may comprise transmitting to the base station, information associated with at least one element of elements that are included in the spatial correlation matrix.

In operation S350, the terminal may select at least one preferred vector from the vectors included in the adaptively generated codebook, based on at least one of an achievable data transmission rate and an SINR.

In operation S360, the terminal may feed back information associated with the selected at least one preferred vector to the base station.

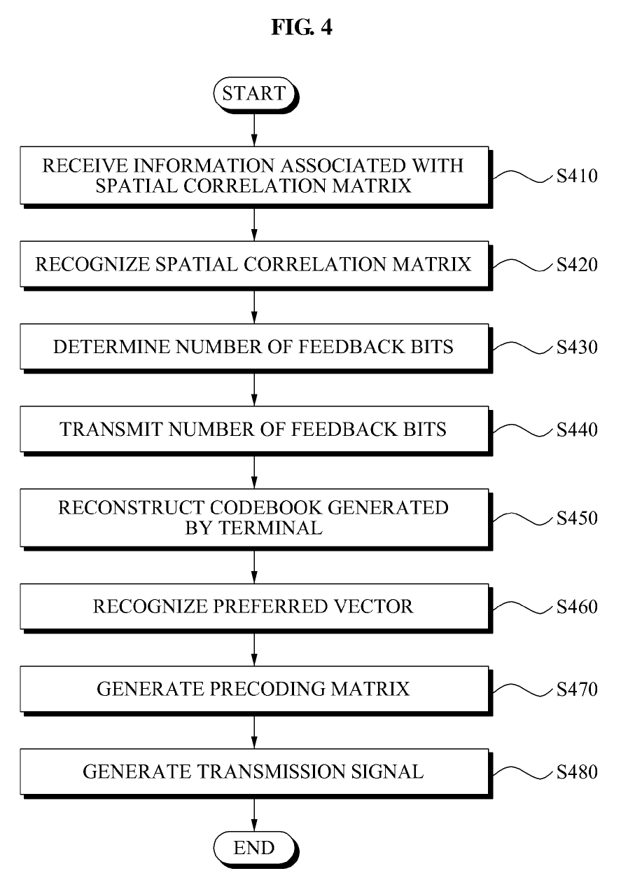

FIG. 4 is a flowchart illustrating a method of operating a base station according to an exemplary embodiment.

In operation S410, the base station may receive information associated with a spatial correlation matrix of a channel matrix from a terminal.

Information associated with the spatial correlation matrix may be information associated with at least one element of elements that are included in the spatial correlation matrix.

In operation S420, the base station may recognize the spatial correlation matrix based on information associated with the spatial correlation matrix of the channel matrix from the terminal.

In operation S430, the base station may determine a portion of limited total bits or all of the limited bits as a number of feedback bits allocated to the terminal based on the spatial correlation matrix and a transmission power.

According to an aspect, operation S430 may be an operation of determining the number of feedback bits to be allocated to the terminal based on singular values of the spatial correlation matrix. Where the transmission power is greater than a reference level, the number of feedback bits allocated to the terminal may be increased as the spatial correlation of the channel increases. Conversely, where the transmission power is less than the reference level, the number of feedback bits allocated to the terminal may be increased as the spatial correlation of the channel decreases. In the operation S430, the number of feedback bits allocated to the terminal may be adjusted in proportion to the transmission power.

In operation S440, the base station may transmit information associated with the determined number of feedback bits to the terminal.

In operation S450, the base station may reconstruct a codebook generated by the terminal based on the number of feedback bits and the spatial correlation matrix. The feedback bits may be allocated to the terminal based on the spatial correlation matrix.

According to an aspect, operation S450 may be an operation of reconstructing the codebook generated by the terminal based on the spatial correlation matrix and a plurality of pre-stored vectors.

According to an aspect, operation S450 may be an operation of reconstructing the codebook by grouping vectors from the plurality of pre-stored vectors according to the number of feedback bits allocated to the terminal, based on a dominant eigenvector of the spatial correlation matrix. Singular values of the spatial correlation matrix may be used.

In operation S460, the base station may recognize a preferred vector from vectors included in the codebook, based on information associated with the preferred vector that is fed back from the terminal.

In operation S470, the base station may generate a preceding matrix based on the preferred vector of the terminal and preferred vectors corresponding to other terminals.

In operation S480, the base station may generate a transmission signal to be transmitted to the terminal, or a portion of the other terminals, or all of the terminals, based on the preceding matrix.

The methods described herein including a base station and terminal operating method may be recorded, stored, or fixed in one or more in computer-readable media that includes program instructions to be implemented by a computer to cause a processor to execute or perform the program instructions. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments.

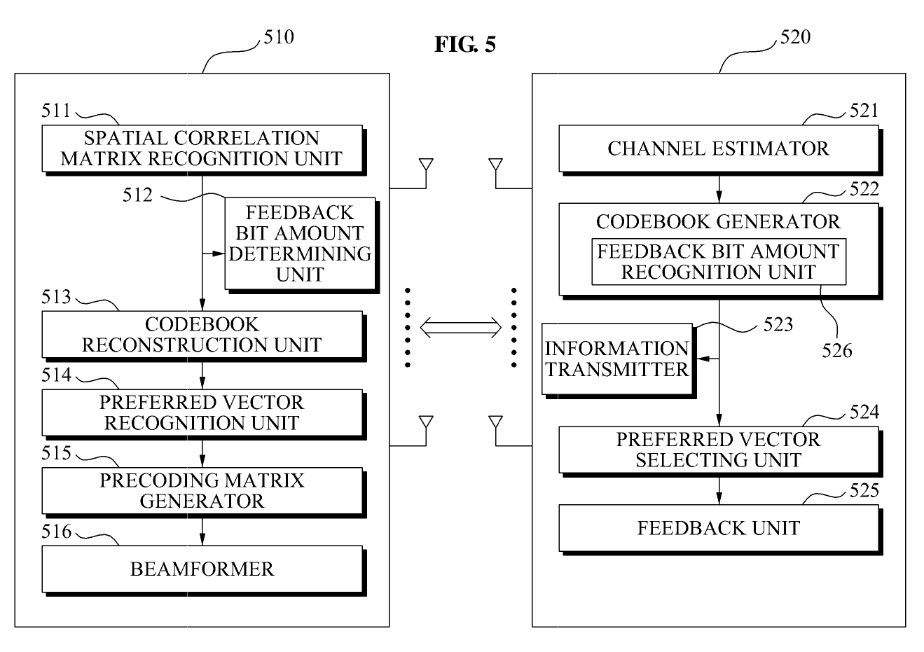

FIG. 5 is a block diagram illustrating a base station 510 and a terminal 520 according to an exemplary embodiment.

The base station 510 includes a spatial correlation matrix recognition unit 511, a feedback bit amount determining unit 512, a codebook reconstruction unit 513, a preferred vector recognition unit 514, a preceding matrix generator 515, and a beamformer 516.

The terminal 520 includes a channel estimator 521, a codebook generator 522, an information transmitter 523, a preferred vector selecting unit 524, and a feedback unit 525.

The channel estimator 521 may estimate a channel formed between the base station 510 and the terminal 520 and calculate a channel matrix.

The codebook generator 522 may adaptively generate a codebook based on a spatial correlation matrix of the channel matrix. According to an aspect, the codebook generator 522 may include a feedback bit amount recognition unit 526 to recognize a number of feedback bits determined by the base station 510. The codebook generator 522 may adaptively generate the codebook based on the determined number of feedback bits.

The codebook generator 522 may adaptively generate the codebook according to the determined number of feedback bits, based on the spatial correlation matrix and a plurality of pre-stored vectors associated with an independent identically distributed channel.

The codebook generator 522 may adaptively generate the codebook by grouping vectors from the plurality of pre-stored vectors according to the number of feedback bits, based on a dominant eigenvector of the spatial correlation matrix.

The information transmitter 523 may transmit information associated with the spatial correlation matrix to the base station 510.

The spatial correlation matrix recognition unit 511 may recognize the spatial correlation matrix based on information associated with the spatial correlation matrix of a channel matrix that is received from the terminal 520.

The feedback bit amount determining unit 512 may determine a portion of limited total bits or all of the limited total bits as the number of feedback bits allocated to the terminal 520, based on the spatial correlation matrix and a transmission power.

The codebook reconstruction unit 513 may reconstruct a codebook generated by the terminal 520 based on the number of feedback bits and the spatial correlation matrix. The feedback bits are allocated to the terminal 520 based on the spatial correlation matrix.

The preferred vector selecting unit 524 may select at least one preferred vector from vectors that are included in the adaptively generated codebook, based on at least one of an achievable data transmission rate and an SINR.

The feedback unit 525 may feed back information associated with the selected at least one preferred vector to the base station 510. The feedback unit 525 may feed back information with the at least one preferred vector and the information is quantized according to a predetermined number of feedback bits.

The preferred vector recognition unit 514 may recognize the preferred vector from vectors included in the codebook, based on information associated with the preferred vector that is fed back from the terminal 520.

The preceding matrix generator 515 may generate a preceding matrix based on the preferred vector of the terminal and preferred vectors corresponding to other terminals.

The beamformer 516 may generate a transmission signal to be transmitted to the terminal, or a portion of the other terminals, or all of the terminals, based on the preceding matrix.

Elements shown in FIG. 5 but not described herein have been described above with respect to the corresponding elements of FIGS. 1 through 4. Accordingly, further descriptions will be omitted.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims

What is claimed is:

1. A terminal comprising:
a channel estimator to estimate a channel formed between a base station and the terminal to calculate a channel matrix; and
a codebook generator to adaptively generate a codebook based on a spatial correlation matrix of the channel matrix.

2. The terminal as claimed in claim 1, wherein the codebook generator adaptively generates the codebook according to a predetermined number of feedback bits.

3. The terminal as claimed in claim 1, wherein the codebook generator adaptively generates the codebook based on the spatial correlation matrix and a plurality of pre-stored vectors.

4. The terminal as claimed in claim 3, wherein the plurality of pre-stored vectors is associated with an independent identically distributed channel.

5. The terminal as claimed in claim 1, wherein the codebook generator adaptively generates the codebook by grouping vectors from a plurality of pre-stored vectors associated with a dominant eigenvector of the spatial correlation matrix according to a number of feedback bits.

6. The terminal as claimed in claim 5, wherein the codebook generator adaptively generates the codebook based on singular values of the spatial correlation matrix.

7. The terminal as claimed in claim 5, wherein the codebook generator adaptively generates the codebook by selecting a centroid vector from the plurality of pre-stored vectors and grouping the vectors from the plurality of pre-stored vectors according to the number of feedback bits based on at least one of a correlation between the centroid vector and the plurality of pre-stored vectors, and a correlation between the plurality of pre-stored vectors, wherein the centroid vector maximizes an inner product between the plurality of pre-stored vectors and the dominant eigenvector.

8. The terminal as claimed in claim 5, wherein the plurality of pre-stored vectors is vectors that are included in a discrete Fourier transform (DFT) codebook.

9. The terminal as claimed in claim 1, further comprising:
an information transmitter to transmit information associated with the spatial correlation matrix to the base station.

10. The terminal as claimed in claim 9, wherein the information transmitter transmits, to the base station, information associated with at least one element of elements that are included in the spatial correlation matrix.

11. The terminal as claimed in claim 1, further comprising:
a preferred vector selector to select at least one preferred vector from vectors that are included in the adaptively generated codebook, based on at least one of an achievable data transmission rate and a signal-to-interference and noise ratio (SINR).

12. The terminal as claimed in claim 11, further comprising:
a feedback unit to feed back information associated with the at least one preferred vector to the base station.

13. The terminal as claimed in claim 12, wherein the information associated with the at least one preferred vector is quantized according to a predetermined number of feedback bits.

14. The terminal as claimed in claim 13, wherein the predetermined number of feedback bits is determined by the base station.

15. The terminal as claimed in claim 1, wherein the channel matrix is expressed in a vector form where the terminal is provided with a single antenna.

16. A base station comprising:
a spatial correlation matrix recognition unit to recognize a spatial correlation matrix based on information associated with the spatial correlation matrix of a channel matrix that is received from a terminal, wherein the channel matrix is a channel formed between the terminal and the base station; and
a codebook reconstruction unit to reconstruct a codebook generated by the terminal based on a number of feedback bits and the spatial correlation matrix.

17. The base station as claimed in claim 16, wherein the feedback bits is allocated to the terminal based on the spatial correlation.

18. The base station as claimed in claim 16, further comprising:
a feedback bit amount determining unit to determine a portion of limited total bits or all of the limited total bits as the number of feedback bits allocated to the terminal, based on the spatial correlation matrix and a transmission power.

19. The base station as claimed in claim 18, wherein the feedback bit amount determining unit determines the number of feedback bits allocated to the terminal based on singular values of the spatial correlation matrix.

20. The base station as claimed in claim 18, wherein, where the transmission power is high, the feedback bit amount determining unit increases the number of feedback bits allocated to the terminal as the spatial correlation of the channel increases, and where the transmission power is low, the feedback bit amount determining unit increases the number of feedback bits allocated to the terminal as the spatial correlation of the channel decreases.

21. The base station as claimed in claim 18, wherein the feedback bit amount determining unit adjusts the number of feedback bits allocated to the terminal in proportion to the transmission power.

22. The base station as claimed in claim 16, wherein information associated with the spatial correlation matrix includes information associated with at least one element of elements that are included in the spatial correlation matrix.

23. The base station as claimed in claim 16, wherein the codebook reconstruction unit reconstructs the codebook generated by the terminal based on the spatial correlation matrix and a plurality of pre-stored vectors.

24. The base station as claimed in claim 16, wherein the codebook reconstruction unit reconstructs the codebook by grouping vectors from a plurality of pre-stored vectors according to the number of feedback bits allocated to the terminal, based on a dominant eigenvector of the spatial correlation matrix.

25. The base station as claimed in claim 24, wherein the codebook reconstruction unit reconstructs the codebook based on singular values of the spatial correlation matrix.

26. The base station as claimed in claim 16, further comprising:
a preferred vector recognition unit to recognize a preferred vector from vectors included in the codebook, based on information associated with the preferred vector that is fed back from the terminal.

27. The base station as claimed in claim 26, further comprising:
a precoding matrix generator to generate a precoding matrix based on the preferred vector of the terminal and preferred vectors corresponding to other terminals.

28. The base station as claimed in claim 27, further comprising:
a beamformer to generate a transmission signal to be transmitted to the terminal, or a portion of the other terminals, or all of the terminals, based on the precoding matrix.

29. A method of operating a terminal, comprising:
estimating a channel formed between a base station and a terminal to calculate a channel matrix;
adaptively generating a codebook based on a spatial correlation matrix of the channel matrix;
transmitting information associated with the spatial correlation matrix to the base station;
selecting a preferred vector from the adaptively generated codebook; and
feeding back information associated with the preferred vector to the base station.

30. The method as claimed in claim 29, wherein selecting of the preferred vector comprises selecting the preferred vector based on at least one of an achievable data transmission rate and an SINR.

31. A method of operating a base station, comprising:
recognizing a spatial correlation matrix based on information associated with the spatial correlation matrix of a channel matrix that is received from a terminal;
determining a number of feedback bits allocated to the terminal based on the spatial correlation matrix and a transmission power;
reconstructing a codebook generated by the terminal according to the number of feedback bits and the spatial correlation matrix;
recognizing a preferred vector from the codebook based on information associated with the preferred vector that is fed back from the terminal;
generating a precoding matrix based on the preferred vector of the terminal; and
generating a transmission signal to be transmitted to the terminal based on the precoding matrix.
